(19) United States
(12) Patent Application Publication
(10) Pub. No.: US 2009/0228204 A1
(43) Pub. Date: Sep. 10, 2009

(54) SYSTEM AND METHOD FOR MAP MATCHING WITH SENSOR DETECTED OBJECTS

(75) Inventors: Walter B. Zavoli, Palo Alto, CA (US); Marcin Michal Kmiecik, Lodz (PL); Stephen T'Siobbel, Merelbeke (BE); Volker Hiestermann, Hanover (DE)

Correspondence Address: FLIESLER MEYER LLP, 650 CALIFORNIA STREET, 14TH FLOOR, SAN FRANCISCO, CA, 94108, US

(73) Assignees: TELA ATLAS NORTH AMERICA, INC., Lebanon, NH (US); TELA ATLAS B.V., BX 'sHertogenbosch (NL)

(21) Appl. No.: 12/365,119

(22) Filed: Feb. 3, 2009

Related U.S. Application Data
(60) Provisional application No. 61/026,063, filed on Feb. 4, 2008.

(51) Int. Cl. G01C 21/26

(52) U.S. Cl. 701/208

(57) ABSTRACT

A system and method for map matching with sensor detected objects. A direct sensor and object matching technique can be used to disambiguate objects that the driver passes. The technique also makes it possible for the navigation system to refine (i.e. improve the accuracy of) its position estimate. In some embodiments, a camera in the car can be used to produce, dynamically in real time, images of the vicinity of the vehicle. Map and object information can then be retrieved from a map database, and superimposed on those images for viewing by the driver, including accurately defining the orientation or the platform so that the alignment of the map data and the image data is accurate. Once alignment is achieved, the image can be further enhanced with information retrieved from the database about any in-image objects. Objects may be displayed accurately on a map display as icons that help the driver as he/she navigates the roads.

### CLAIM OF PRIORITY

This application claims the benefit of priority to U.S. Provisional Patent Application No. 61/026,063, titled “SYSTEM AND METHOD FOR MAP MATCHING WITH SENSOR DETECTED OBJECTS”; filed Feb. 4, 2008, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention relates generally to digital maps, geographical positioning systems, and vehicle navigation, and particularly to a system and method for map matching with sensor detected objects.

### BACKGROUND

Within the past several years, navigation systems, electronic maps (also referred to herein as digital maps), and geographical positioning devices, have been increasingly employed to provide various navigation functions. Examples of such navigation functions include determining an overall position and orientation of a vehicle; finding destinations and addresses; calculating optimal routes; and providing real-time driving guidance, including access to business listings or yellow pages.

Generally, a navigation system portrays a network of streets, rivers, buildings, and other geographical and man-made features, as a series of line segments including, within the context of a driving navigation system, a centerline running approximately along the center of each street. A moving vehicle can then be located on the map close to, or with regard to, that centerline.

Some earlier navigation systems, such as those described in U.S. Pat. No. 4,796,191, have relied primarily on relative-position determination sensors, together with a “dead-reckoning” feature, to estimate the current location and heading of the vehicle. However, this technique is prone to accumulating small amounts of positional error. The error can be partially corrected with a “map matching” algorithm, wherein the map matching algorithm compares the dead-reckoned position calculated by the vehicle's computer with a digital map of streets, to find the most appropriate point on the street network of the map, if such a point can indeed be found. The system then updates the vehicle's dead-reckoned position to match the presumably more accurate “updated position” on the map.

Other forms of navigation systems have employed beacons (for example radio beacons, sometimes also referred to as electronic signposts) to provide position updates and to reduce positional error. For several reasons, including high installation costs, electronic signposts were often spaced at very low densities. This means that errors would often accumulate to unacceptable levels before another beacon or electronic signpost could be encountered and used for position confirmation. Thus, even with the use of beacons, techniques such as map matching were still required to eliminate or at least significantly reduce the accumulated error.

The map matching technique has also proven useful in providing meaningful “real-world” information to the driver about his/her current location, orientation, vicinity, destination, route; or information about destinations to be encountered along a particular trip. The form of map matching disclosed in U.S. Pat. No. 4,796,191 might be considered “inferential”, i.e. the disclosed algorithm seeks to match the dead-reckoned (or otherwise estimated) track of the vehicle with a road network encoded in the map. The vehicle has no direct measurements of the road network; instead, the navigation system merely estimates the position and heading of the vehicle and then seeks to compare those estimates to the position and heading of known road segments. Generally, such map matching techniques are multidimensional, and take into account numerous parameters, the most significant being the distance between the road and estimated position, and the heading difference between the road and estimated vehicle heading. The map can also include absolute coordinates attached to each road segment. A typical dead reckoning system might initiate the process by having the driver identify the location of the vehicle on the map. This enables the dead-reckoned position to be provided in terms of absolute coordinates. Subsequent dead-reckoned determinations (i.e. incremental distance and heading measurements) can then be used to compute a new absolute set of coordinates, and to compare the new or current dead reckoned position with road segments identified in the map as being located in the vicinity of the computed dead reckoned position. The process can then be repeated as the vehicle moves. An estimate of the positional error of the current dead reckoned position can be computed along with the position itself. This error estimate in turn defines a spatial area within which the vehicle is likely to be, within a certain probability. If the determined position of the vehicle is within a calculated distance threshold of the road segment, and the estimated heading is within a calculated heading difference threshold of the heading computed from the road segment information, then it can be inferred with some probability that the vehicle must be on that section of the road. This allows the navigation system to make any necessary corrections to eliminate any accumulated error.

With the introduction of reasonably-priced Geographical Positioning System (GPS) satellite receiver hardware, a GPS receiver can also be added to the navigation system to receive a satellite signal and to use that signal to directly compute the absolute position of the vehicle. However, even with the benefits of GPS, map matching is typically used to eliminate errors within the received GPS signal and within the map, and to more accurately show the driver where he/she is on that map. Although on a global or macro-scale satellite technology is extremely accurate; on a local or micro-scale small positional errors still do exist. This is primarily because the GPS receiver may experience an intermittent or poor signal reception or a signal distortion; and because both the centerline representation of the streets and the measured position from the GPS receiver may only be accurate to within several meters. Higher performing systems use a combination of dead-reckoning and GPS to reduce position determination errors, but even with this combination, errors can still occur to a degree of several meters or more.

In some instances, inertial sensors can be added to provide a benefit over moderate distances, but over larger distances even those systems that include inertial sensors will accumulate error.

However, while vehicle navigation devices have gradually improved over time, becoming more accurate, feature-rich, cheaper, and popular; they still fall behind the increasing demands of the automobile industry; and in particular, it is expected that future applications will require higher positional accuracy, and even more detailed, accurate, and feature-rich maps. This is the area that embodiments of the present invention are designed to address.

### SUMMARY

Embodiments of the present invention address the above-described problems by providing a direct sensor and object matching technique. The direct sensor and object matching technique can be used to disambiguate objects that the driver passes, and make it precisely clear which one of the objects the retrieved information is referring to. The technique also makes it possible for the navigation system to refine (i.e. improve the accuracy of) its position estimate, without user attention.

In accordance with an embodiment that uses scene matching, a system is provided which (a) extracts one or more scenes from the sensor-gathered or raw data; (b) builds a corresponding scene from a map-provided or stored version of the raw data; and (c) compares the two scenes to help provide a more accurate estimate of the vehicle position.

In accordance with an embodiment that uses vehicle-object position matching, a system is provided which (a) extracts raw object data from the sensor-gathered or raw data; (b) compares the extracted data with a corresponding raw object data kept in map from a map-provided or stored version of the raw data; and (c) compares the two measures of object data to help provide a more accurate estimate of the vehicle position.

In accordance with an embodiment uses object characterization, a system is provided which (a) extracts raw object data from the sensor-gathered or raw data; (b) extracts characteristics from those raw objects; and (c) compares those characteristics with the characteristics that are stored in the map to help provide a more accurate estimate of the vehicle position.

In some embodiments, a camera or sensor in the car can be used to produce, dynamically in real time, images of the vicinity of the vehicle. Using direct sensor/object matching techniques map and object information can then be retrieved from a map database, and superimposed on those images for viewing by the driver, including accurately defining the orientation or the platform so that the alignment of the map data and the image data is accurate. Once alignment is achieved, the image can be further enhanced with information retrieved from the database about any in-image objects. The system reduces the need for other, more costly solutions, such as the use of high accuracy systems to directly measure orientation. In some embodiments, once the navigation system is sensor-matched to objects in the vicinity, these objects may be displayed accurately on a map display as icons that help the driver as he/she navigates the roads. For example, an image (or icon representation) of a stop sign, lamppost, or mailbox can be placed on the driver's display in an accurate position and orientation to the driver's actual perspective or point of view. These cue-objects are used to cue the driver to his/her exact position and orientation. In some embodiments, the cue-objects may even be used as markers for the purpose of the system giving clear and practical directions to the driver (for example, “At the stop sign, turn right onto California Street; Your destination is then four meters past the mailbox”).

In some embodiments, once the navigation system is sensor-matched to objects in its vicinity, additional details can be displayed, such as signage information that is collected in the map database. Such information can be used to improve the drivers ability to read the signs and understand his/her environment, and are of particular use when the sign is still too far away for the driver to read, or when the sign is obstructed due to weather or other traffic.

In some embodiments, a position and guidance information can be projected onto a driver's front window or windscreen using a heads-up display (HUD). This allows the precise position and orientation information provided by the system to be used to keep the projected display accurately aligned with the roads to be traveled.

### BRIEF DESCRIPTION OF THE FIGURES

FIG. 1 shows an illustration of a vehicle navigation coordinate system together with a selection of real world objects in accordance with an embodiment.

FIG. 2 shows an illustration of one embodiment of a vehicle navigation system.

FIG. 3 shows an illustration of a sensor detected object characterization and map matching that uses scene matching in accordance with an embodiment.

FIG. 4 shows a flowchart of a method for sensor detected object characterization and map matching that uses scene matching, in accordance with an embodiment.

FIG. 5 shows an illustration of a sensor detected object characterization and map matching that uses vehicle-object position matching in accordance with another embodiment.

FIG. 6 shows a flowchart of a method for sensor detected object characterization and map matching that uses vehicle-object position matching, in accordance with an embodiment.

FIG. 7 shows an illustration of a sensor detected object characterization and map matching that uses object characterization in accordance with another embodiment.

FIG. 8 shows a flowchart of a method for sensor detected object characterization and map matching that uses object characterization, in accordance with an embodiment.

FIG. 9 shows an illustration of a sensor detected object characterization and map matching that uses sensor augmentation in accordance with another embodiment.

FIG. 10 shows a flowchart of a method for sensor detected object characterization and map matching that uses sensor augmentation, in accordance with an embodiment.

### DETAILED DESCRIPTION

Described herein is a system and method for map matching with sensor detected objects. A direct sensor and object matching technique can be used to disambiguate objects that the driver passes. The technique also makes it possible for the navigation system to refine (i.e. improve the accuracy of) its position estimate.

For future navigation-related applications, it is anticipated that map matching to the center of a road may be insufficient, even when combined with GPS or inertial sensors. A typical roadway with two lanes of travel in each direction, and a lane of parked cars along each side, may be on the order of 20 meters across. The road center line is an idealized simplification of the road, essentially with a zero width. Inference based map matching is generally unable to help locate which particular lane of the road the vehicle is located in, or even where the vehicle is along the road within a high accuracy (better than say, 5 meters). Today's consumer-level GPS technology may have different sources of error, but it yields roughly the same results as non-GPS technology with respect to overall positional accuracy.

Some systems have been proposed that require much higher levels of absolute accuracies within both the information stored in the map database and the information captured and used for the real time position determination of the vehicle. For example, considering that each typical road lane is about 3 meters wide, if the digital map or map database is constructed to have an absolute accuracy level of less than a meter, and if both the lane information is encoded and the real time vehicle position system are also provided at an accuracy level of less than a meter, then the device or vehicle can determine which lane it currently occupies, within a reasonable certainty. Such an approach has led to the introduction of differential signals, and technologies such as WAAS. Unfortunately, it is extremely expensive and time consuming to produce a map with absolute accuracies of a meter, and that also have a very high, say 95%, reliability rate for the positions of all of the features in that map. It is also extremely expensive to produce a robust real time car-based position determination system that can gather information at similar levels of absolute accuracy, robustness, and confidence.

Other systems propose retrieval of object information on the basis of segment matching. However, such systems only retrieve objects from their memory on the basis of their relationship to a particular road or block segment. At that point the information from all objects associated with that segment can be retrieved and made available to the driver. However, it is still up to the driver to differentiate between the information from various objects.

Still other systems propose collecting object locations on the basis of probe data and using these object locations within a map to improve position estimates. However, such systems do not provide any practical solutions as to how to actually make such a system work in the real world.

As the popularity of navigation systems has gained momentum, and the underlying technology has improved in terms of greater performance and reduced cost, the investment in the underlying map database has enriched the available content (both onboard and off-board), and more demanding end-user applications have started to emerge. For example, companies and government agencies are researching ways to use navigation devices for improved highway safety and vehicle control functions (for example, to be used in automated driving, or collision avoidance). To implement many of these advanced concepts, an even higher level of system performance will be required.

In accordance with an embodiment, the inventors anticipate that the next generation of navigation capabilities in vehicles will comprise electronic and other sensors, for detecting and measuring objects in the vicinity of the vehicle. Examples of these sensors include cameras (including video and still-picture cameras), radars operating at a variety of wavelengths and with a wide assortment of design parameters, laser scanners, and a variety of other receivers and sensors for use with technologies such as nearby radio frequency identification (RFID) and close-by or wireless communications devices.

It will also be increasingly beneficial for applications to know more about the objects than the sensors can directly measure or otherwise sense. For example, the application may need to know what is written on a particular street sign, or where that street sign is relative to other objects nearby. To support this, there will be a need to store more information about such objects in the underlying database, and then to use that information in a more intelligent manner.

One approach is to store object information as part of an electronic map, digital map, or digital map database, or linked to such a database, since the objects will often need to be referred to by spatial coordinates or in relationship to other objects that are also stored in such map databases such as roads, and road attributes. Examples of the types of applications that might use such added object information to enhance a driver's experience are described in U.S. Pat. Nos. 6,047,234; 6,671,615; and 6,836,724.

However, many of the above-described techniques store the object data as a general attribute associated with a street segment. Shortcomings of this particular approach include: a lack of high accuracy placement of the objects in the map database; lack of high accuracy position information of the object's location, relative to other objects in the database; lack of any means of utilizing in-vehicle or on-board sensor data to actively locate such objects. These techniques can only imprecisely match an object passed by a vehicle to those objects in the map database that are in the vicinity or along the road segment that the position determination function of the vehicle has identified, and without the aid of object-detecting sensors. Traditional consumer navigation techniques lack any means to utilize sensor location measurements in addition to map data to accurately and uniquely match the sensed object to the corresponding object in a database.

In some systems, position determination is accomplished for the most part with GPS, possibly with help from dead reckoning and inertial navigation sensors and inference-based map matching. Since the absolute position of both the vehicle's position determination and the positions of objects as stored in the map are subject to significant error (in many instances over 10 m), and since the object density, say on a typical major road segment or intersection, might include 10 or more objects within relatively close proximity, current systems would have difficulty resolving which object is precisely of interest to the driver or to the application. Generally, systems have not been designed with a concept of which object might be visible to an on-board sensor, or how to match that detected object to a database of objects to obtain more precise location or orientation information, or to obtain more information about the object and the vicinity.

Co-pending U.S. patent application Ser. No. 12/034,521, titled “SYSTEM AND METHOD FOR VEHICLE NAVIGATION AND PILOTING INCLUDING ABSOLUTE AND RELATIVE COORDINATES”, herein incorporated by reference, describes a technique for storing objects in a map database that are attributed with both an absolute position and a relative position (relative to other nearby objects also represented in this map). The systems and methods described therein support the future use of in-vehicle sensors, and allow for storing attributes in the map database (or dynamically receiving localized object information on an as-needed basis) that will aid in the unique matching of a sensed object with a map object. U.S. patent application Ser. No. 12/034,521 identifies the need for a robust object matching algorithm, and describes techniques for matching sensor detected and measured objects against their representations in the map. Embodiments of the present invention further address the problem of defining enhanced methods for performing this direct sensed-object map matching.

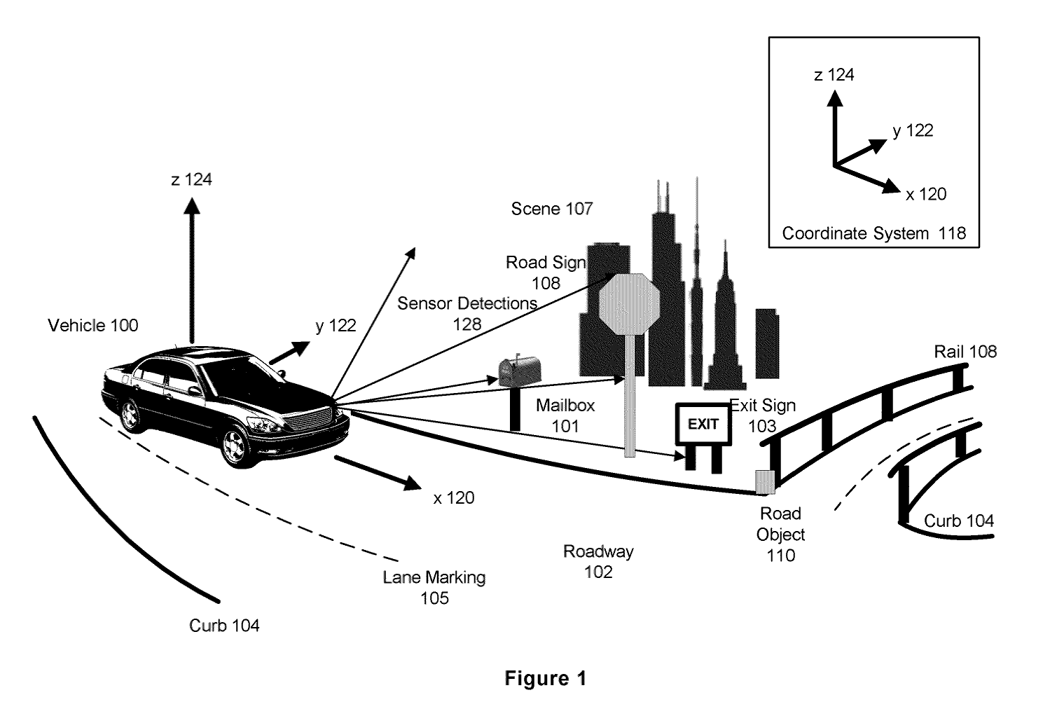

FIG. 1 shows an illustration of a vehicle navigation coordinate system together with a selection of real world objects in accordance with an embodiment. As shown in FIG. 1, a vehicle 100 travels a roadway 102, that includes one or more curbs, road markings, objects, and street furniture, including in this example: curbs 104, lane and or road markings 105 (which can include such features as lane dividers or road centerlines, bridges, and overpasses), road side rails 108, mailboxes 101, exit signs 103, road signs (such as a stop sign) 106, and other road objects 110 or structures. Together, all of these road markings and objects, or a selection of the road markings and objects, can be considered a scene 107 for possible interpretation by the system. It will be evident that the scene, together with the road markings and objects, as shown in FIG. 1, is provided herein by way of example and that many other scenes and different types of road markings and objects can be envisaged and used with embodiments of the present invention.

The road network, vehicle, and objects may be considered in terms of a coordinate system 118, including placement, orientation and movement in the x 120, y 122, and z 124 directions or axes. In accordance with an embodiment, a map database in the vehicle is used to store these objects, in addition to the traditional road network and road attributes. An object such as a stop sign, roadside sign, lamppost, traffic light, bridge, building, or even the a lane marking or a road curb, is a physical object that can be easily seen and identified by eye. In accordance with embodiments of the present invention, some or all of these objects can also be sensed 128 by a sensor such as a radar, laser, scanning laser, camera, RFID receiver or the like, that is mounted on or in the vehicle. These devices can sense an object, and, in many cases, can measure the relative distance and direction of the object relative to the location and orientation of the vehicle. In accordance with some embodiment the sensor can extract other information about the object, such as its size or dimensions, density, color, reflectivity, or other characteristics.

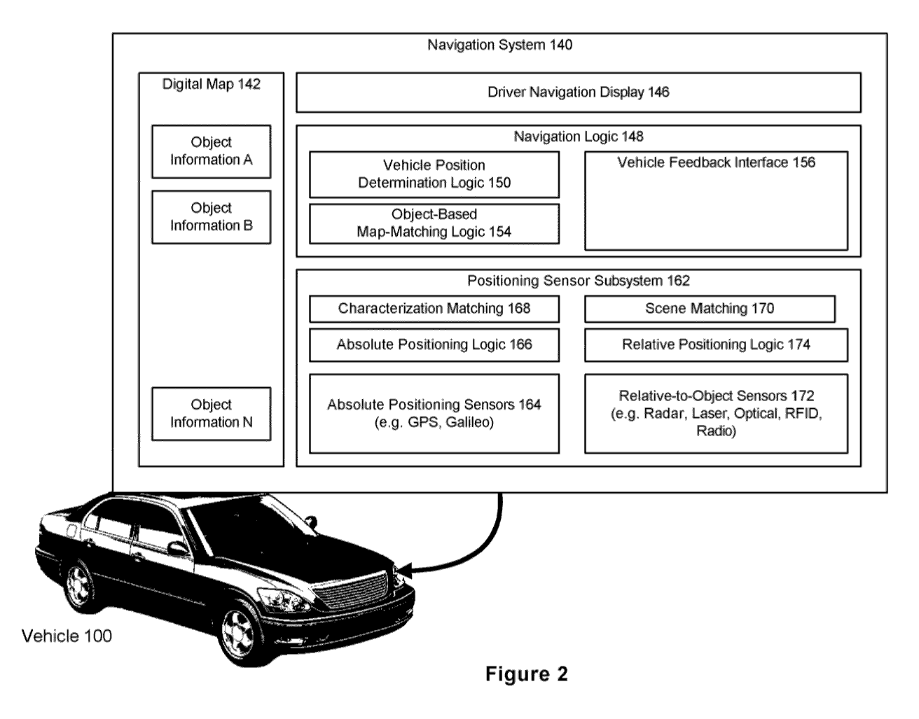

In some implementations the system and/or sensors can be embedded with or connected to software and a micro-processor in the vehicle to allow the vehicle to identify an object in the sensor output in real-time, as the vehicle moves. FIG. 2 shows an illustration of one embodiment of a vehicle navigation system. As shown in FIG. 2, the system comprises a navigation system 140 that can be placed in a vehicle, such as a car, truck, bus, or any other moving vehicle. Alternative embodiments can be similarly designed for use in shipping, aviation, handheld navigation devices, and other activities and uses. The navigation system comprises a digital map or map database 142, which in turn includes a plurality of object information. Alternately, some or all of this map database may be stored off-board and selected parts communicated to the device as needed. In accordance with an embodiment, some or all of the object records include information about the absolute and/or the relative position of the object (or raw sensor samples from objects). The navigation system further comprises a positioning sensor subsystem 162. In accordance with an embodiment, the positioning sensor subsystem includes a object characterization logic 168, scene matching logic 170, and a combination of one or more absolute positioning logics 166 and/or relative positioning logics 174. In accordance with an embodiment the absolute positioning logic obtains data from absolute positioning sensors 164, including for example GPS or Galileo receivers. This data can be used to obtain an initial estimate as to the absolute position of the vehicle. In accordance with an embodiment, the relative positioning logic obtains data from relative positioning sensors, including for example radar, laser, optical (visible), RFID, or radio sensors. This data can be used to obtain an estimate as to the relative position or bearing of the vehicle compared to an object. The object may be known to the system (in which case the digital map will include a record for that object), or unknown (in which case the digital map will not include a record). Depending on the particular implementation, the positioning sensor subsystem can include either one of the absolute positioning logic, or the relative positioning logic, or can include both forms of positioning logic.

The navigation system further comprises a navigation logic 148. In accordance with an embodiment, the navigation logic includes a number of additional components, such as those shown in FIG. 2. It will be evident that some of the components are optional, and that other components may be added as necessary. At the heart of the navigation logic is a vehicle position determination logic 150 and/or object-based map-matching logic 154. In accordance with an embodiment, the vehicle position determination logic receives input from each of the sensors, and other components, to calculate an accurate position (and bearing if desired) for the vehicle, relative to the coordinate system of the digital map, other vehicles, and other objects. A vehicle feedback interface 156 receives the information about the position of the vehicle. This information can be used by the driver, or automatically by the vehicle. In accordance with an embodiment, the information can be used for driver feedback (in which case it can also be fed to a driver's navigation display 146). This information can include position and orientation feedback, and detailed route guidance.

In accordance with some embodiments, objects in the vicinity of a vehicle are actually processed, analyzed, and characterized for use by the system and/or the driver. In accordance with alternative embodiments, information about the object characteristics does not need to be extracted or completely “understood” from the sensor data; instead in these embodiments only the raw data that is returned from a sensor is used for the object or scene matching. Several different embodiments using one or more of these techniques are described below.

### Scene Matching

In accordance with an embodiment that uses scene matching, a system is provided which (a) extracts one or more scenes from the sensor-gathered or raw data; (b) builds a corresponding scene from a map-provided or stored version of the raw data; and (c) compares the two scenes to help provide a more accurate estimate of the vehicle position.

Advantages of this embodiment include that the implementation is relatively easy to implement, and is objective in nature. Adding more object categories to the map database does not influence or change the underlying scene matching process. This allows a map customer to immediately benefit when new map content is made available. They do not have to change the behavior of their application platform. Generally, this embodiment may also require greater storage capacity and processing power to implement.

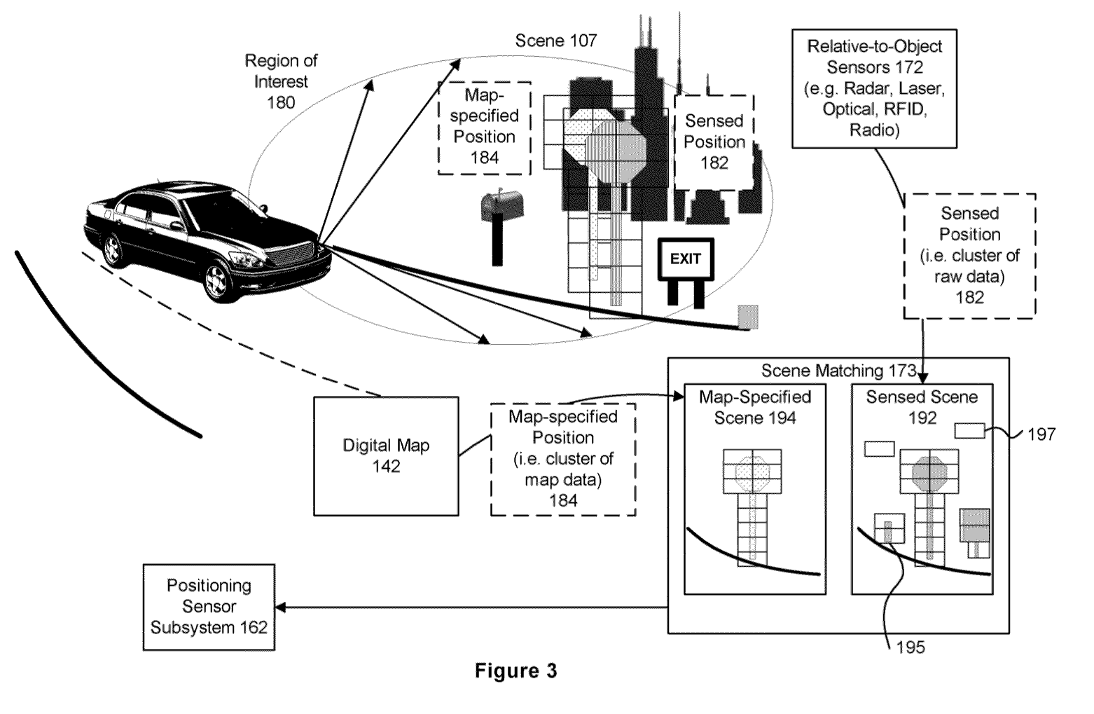

FIG. 3 shows an illustration of a sensor detected object characterization and map matching that uses scene matching in accordance with an embodiment. In accordance with this embodiment, the in-vehicle navigation system does not need to process the sensor data to extract any specific object. Instead, the sensor builds a two-dimensional (2D) or three-dimensional (3D) scene of the space it is currently sensing. The sensed scene is then compared with a corresponding map-specified 2D or 3D scene or sequence of scenes, as retrieved from the map database. The scene matching is then used to make the appropriate match between the vehicle and the objects, and this information is used for position determination and navigation.

In accordance with an embodiment, and as further described in co-pending U.S. patent application Ser. No. 12/034,521, the vehicle's onboard navigation system may have, at some initial time, only an absolute measurement of position. Alternatively, after a period of time of applying the techniques described in U.S. patent application Ser. No. 12/034,521, the vehicle may have matched to several or to many objects, which have served to also improve the vehicles position and orientation estimate and define the vehicles position and orientation in the appropriate relative coordinate space, as well as possibly improve its estimate on an absolute coordinate basis. In this case the vehicle may have a more accurate position and orientation estimate at least in local relative coordinates. In either case an estimate of positional location accuracy, referred to herein as a contour of equal probability (CEP) can be derived.

In either case the navigation system can place its current estimated location on the map (using either absolute or relative coordinates). In the case of an unrefined absolute location the CEP may be moderately large (perhaps 10 meters). In the case of a relative location or an enhanced absolute location, the CEP will be proportionately smaller (perhaps 1 meter). The navigation system can also estimate a current heading, and hence define the position and heading of the scene that is built up by the sensor.

In accordance with some embodiments, the scene viewed by the navigation system can then be generated as a three dimensional return matrix of a radar, or as a two dimensional projection of radar data, referred to in some embodiments herein as a Vehicle Spatial Object Data (VSOD). In accordance with other embodiments, the scene can comprise an image taken from a camera, or a reflection matrix built by a laser scanner. The scene can also be a combination of a radar or laser scan matrix, colorized by an image collected with a visible-light camera.

In some embodiments, the scene being interpreted can be limited to a Region of Interest (ROI) that is defined as the region or limits of where matching objects are likely to be found. For example, using a laser scanner as a sensor, the scene can be limited to certain distances from the on board sensor, or to certain angles representing certain heights. In other embodiments, the ROI can be limited to distances between, say, 1 and 10 meters from the scanner, and angles between, say, −30 degrees and plus 30 degrees with respect to the horizontal that correspond respectively to ground level and to a height of 5 meters at the close-in boundary of the ROI. This ROI boundary might be defined and tuned to capture, for example, all of the objects along a sidewalk or along the side of the road. As the vehicle moves, the ROI allows the navigation system to focus on regions of most interest, which reduces the complexity of the scene it must analyze, and similarly reduces the computation needs to match that scene.

As further shown in FIG. 3, in accordance with some embodiments, a laser scanner reflection cluster can be superimposed onto a 3D scene as constructed from the objects in the map database. In the example shown in FIG. 3, while the vehicle 100 travels a roadway, and uses sensors 172 to evaluate a region of interest 180, it can perceive a scene 107, including a sensed object 182 as a cluster of data. As shown in FIG. 3, the cluster can be viewed and represented as a plurality of boxes corresponding to the resolution of the laser scanner, which in accordance with one embodiment is about 1 degree and results in a 9 cm square resolution or box at a distance of approximately 5 meters. The object that generated the laser scan cluster, in this instance a road sign, is shown in FIG. 3 behind the cluster resolution cells. To the vehicle navigation system, the object, together with any other objects in the ROI, can be considered a scene 107 for potential matching by the system.

In accordance with an embodiment, each of a plurality of objects can also be stored in the map database 142 as raw sensor data (or a compressed version thereof). Information for an object 184 in the scene can be retrieved from the map database by the navigation system. The example shown in FIG. 3 shows the stored raw sensor data and a depiction of the object as another road sign 184 or plurality of boxes, in this instance “behind” the sensor data. As such, FIG. 3 represents the map version of the object scene 194, and also the real-time sensor version of the same object scene 192, as computed in a common 3-D coordinate system. As shown in FIG. 3, the real-time sensor version of the object scene 192 can sometimes include extraneous signals or noise from other objects within a scene, including signals from nearby objects; signals from objects that are not yet known within the map database 195 (perhaps an object that was recently installed into the physical scene and has not yet been updated to the map); and occasional random noise 197. In accordance with an embodiment, some initial cleanup can be performed to reduce these additional signals and noise. The two scenes can then be matched 170 by the navigation system. Resulting information can then be passed back to the positioning sensor subsystem 162.

In accordance with an embodiment, the map database contains objects defined in a 2-D and/or 3-D space. Objects, such as road signs, can be attributed to describe for example the type of sign and its 3-D coordinates in absolute and/or relative coordinates. The map data can also contain characteristics such as the color of the sign, type of sign pole, wording on sign, or its orientation. In addition, the map data for that object can also comprise a collection of raw sensor outputs from, e.g. a laser scanner, and/or a radar. An object data can also comprise a 2-D representation, such as an image, of the object. The precise location of individual objects as seen in the scene can also be contained as attributes in the map database as to their location within the scene. These attributes are collected and processed during the original mapping/data collection operation, and may be based on manual or automatic object recognition techniques. Some additional techniques that can be used during this step are disclosed in copending PCT Patent Applications No. PCT_{—}6011206 and PCT_{—}6011865, each of which applications are herein incorporated by reference.

If the system knows the type of sensor(s) in the vehicle, the location of the sensor on the vehicle (for example its height above ground, and its orientation with respect to center front and level of the vehicle), and the location and orientation estimates of the vehicle, then it can compute a scene of the objects contained in the map that serves to replicate the scene captured by the sensor in the vehicle. The scenes (including the objects) from the two sources can be placed in the same coordinate reference system for comparison or matching purposes. For example, in those embodiments that utilize VSOD, the data captured by the sensor of the vehicle can be placed in the coordinates of the map data, using the vehicle's estimate of location and orientation, in addition to the known relationship of the sensor position/orientation with respect to the vehicle. This is the vehicle scene. Simultaneously, Map Spatial Object Data (MSOD) can be constructed from the objects in the map and the position and orientation estimates from the vehicle. This is the map scene. The two data sources produce scenes that position both objects as best as they can, based on the information contained by (a) the map database, and (a) the vehicle and its sensors. If there are no additional errors, then these two scenes should match perfectly if they were superimposed.

Depending on which sensor(s) the vehicle employs, the scene can be produced as a matrix of radar returns, or laser reflections or color pixels. In accordance with an embodiment, features are included to make the data received from the two sources be as comparable as possible. Scaling or transformation can be included to perform this. In accordance with an embodiment, the navigation system can mathematically correlate the raw data in the two scenes. For example, if the scene is constructed as a 2D “image” (and here the term image is used loosely to also include such raw data as radar clusters and radio frequency signals), then the two scene versions (vehicle and map) can be correlated in two dimensions. If the scene is constructed as a 3D “image” then the two scene versions can be correlated in three dimensions. Considering again the example shown in FIG. 3, it will be seen that the two scenes shown therein are not in exact agreement, i.e. the sensed position and the map-specified position do not match up exactly. This could be because of errors in the position and orientation estimates of the vehicle, or the data in the map. In this example, the map object is still well within a CEP centered on the object sensed by the vehicle. Correlation can be performed on the three x y and z coordinates of the scene, to find the best fit and indeed the level of fit, i.e. the level of similarity between the scenes.

Typically, during implementation of the system, a design engineer will select the best range and increments to use in the correlation function. For example, the range of correlation in the z or vertical direction should have a range that encompasses the distance of the CEP in that dimension which should generally be small, since it is not likely that the estimated value of the vehicle above ground will change appreciably. The range of correlation in the y dimension (parallel to the road/vehicle heading) should have a range that encompasses the distance of the y component of the CEP. Similarly, the range of correlation in the x dimension (orthogonal to the direction of the direction of the road) should have a range that encompasses the distance of the x component of the CEP. Suitable exact ranges can be determined for different implementations. The increment distance used for correlation is generally related to (a) the resolution of the sensor and (b) the resolution of the data maintained in the map database.

In accordance with an embodiment, the scene can be a simple depiction of raw sensor resolution points, for example a binary data set placing a value of 1 in every resolution cell with a sensor return and a value of 0 everywhere else. In this instance, the correlation becomes a simple binary correlation: for example, for any lag in the 3D space, counting the number of cells that are 1 in both scenes and normalized by the average number of ones in both scenes. A search is made to find the peak of the correlation function, and the peak is tested against a threshold to determine if the two scenes are sufficiently similar to consider them a match. The x, y, z lags at the maximum of the correlation function then represent the difference between the two position estimates in coordinate space. In accordance with an embodiment the difference can be represented as an output of correlation by a vector in 2D, 3D, and 6 degrees of freedom respectively. This difference can be used by the navigation system to determine the error of the vehicle position, and to correct it as necessary.

It should be noted that a mismatch between map and sensor may be a result of an orientation error rather than a position error. While this is not expected to be a significant source of error, in accordance with some embodiments map scenes can be produced to bracket possible orientation errors. Similarly the system can be designed to adjust for scale errors which may have resulted from errors in determining the position.

As described above, an example of the scene correlation uses 0's and 1's to signify the presence or absence of sensor returns at specific x, y, z locations. Embodiments of the present invention can be further extended to use other values such as the return strength value from the sensor, or a color value, perhaps as developed by colorizing scanning laser data with color image data collected with a mounted camera on the vehicle and location-referenced to the vehicle and hence the scanner. Other manner of tests could be applied outside the correlation function to further test the reliability of any correlation, for example size, average radar crossection, reflectivity, average color, and detected attributes.

In accordance with an embodiment, the image received from the sensor can be processed, and local optimization or minimization techniques can be applied. An example of a local minimum search technique is described in Huttenlocher: Hausdorff-Based Image Comparison (http://www.cs.cornell.edu/vision/hausdorff/hausmatch.html), which is herein incorporated by reference. In this approach, the raw sensor points are processed by an edge detection means to produce lines or polygons, or, for a 3D set of data, a surface detection means can be used to detect an objects face. Such detection can be provided within the device itself (e.g. by using the laser scanner and/or radar output surface geometry data which define points on a surface). The same process can be applied to both the sensed data and the map data. In accordance with some embodiments, to reduce computation time the map data may be already stored in this manner. The Hausdorff distance is computed, and a local minimum search performed. The result is then compared with thresholds or correlated, to determine if a sufficiently high level of match has been obtained. This process is computationally efficient and exhibits a good degree of robustness with respect to errors in scale and orientation. The process can also tolerate a certain amount of scene error.

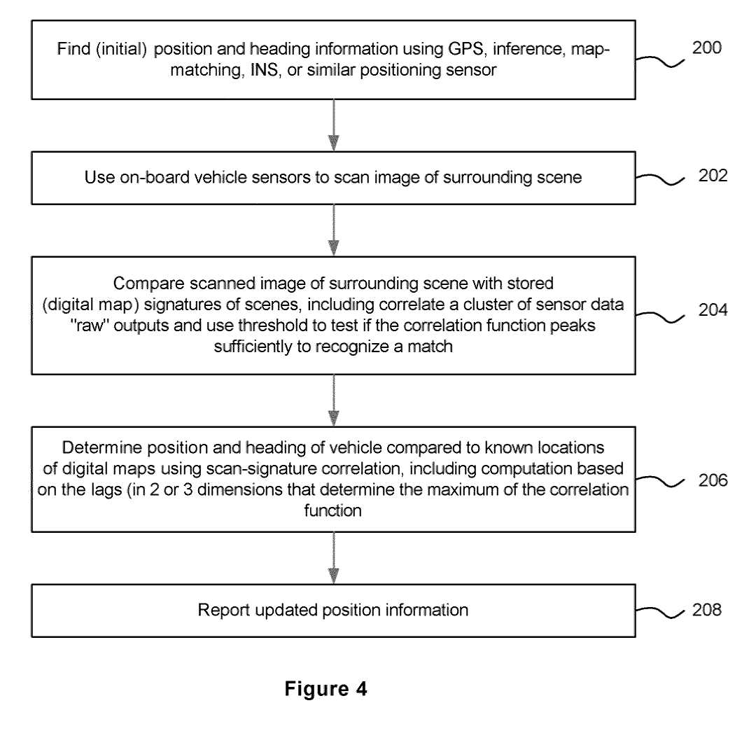

FIG. 4 shows a flowchart of a method for sensor detected object characterization and map matching that uses scene matching, in accordance with an embodiment. As shown in FIG. 4, in step 200, the system finds an (initial) position and heading information using GPS, inference, map-matching, INS, or similar positioning sensor or combination thereof. In step 202, the on-board vehicle sensors can be used to scan or produce an image of the surrounding scene, including objects, road markings, and other features therein. In step 204, the system compares the scanned image of the surrounding scene with stored signatures of scenes. These can be provided by a digital map database or other means. In accordance with some embodiments, the system correlates a cluster of sensor data “raw” outputs, and uses a threshold value to test if the correlation function peaks sufficiently to recognize a match. In step 206, the position and heading of the vehicle are determined compared to known locations in the digital map using scan-signature correlation, including in some embodiments a computation based on the lags (in 2 or 3 dimensions) that determine the maximum of the correlation function. In step 208, the updated position information can then be reported back to the vehicle, system and/or driver.

### Vehicle-Object Position Matching

In accordance with an embodiment that uses vehicle-object position matching, a system is provided which (a) extracts raw object data from the sensor-gathered or raw data; (b) compares the extracted data with a corresponding raw object data kept in map from a map-provided or stored version of the raw data; and (c) compares the two measures of object data to help provide a more accurate estimate of the vehicle position.

Advantages of this embodiment include that the implementation is objective, and can also easily incorporate other object comparison techniques. This embodiment may also require lower processing power than the scene matching described above. However, the extraction is dependent on the categories that are stored in the map. If new categories are introduced, then the map customer must update their application platform accordingly. Generally, the map customer and map provider should agree beforehand on the stored categories that will be used. This embodiment may also require greater storage capacity.

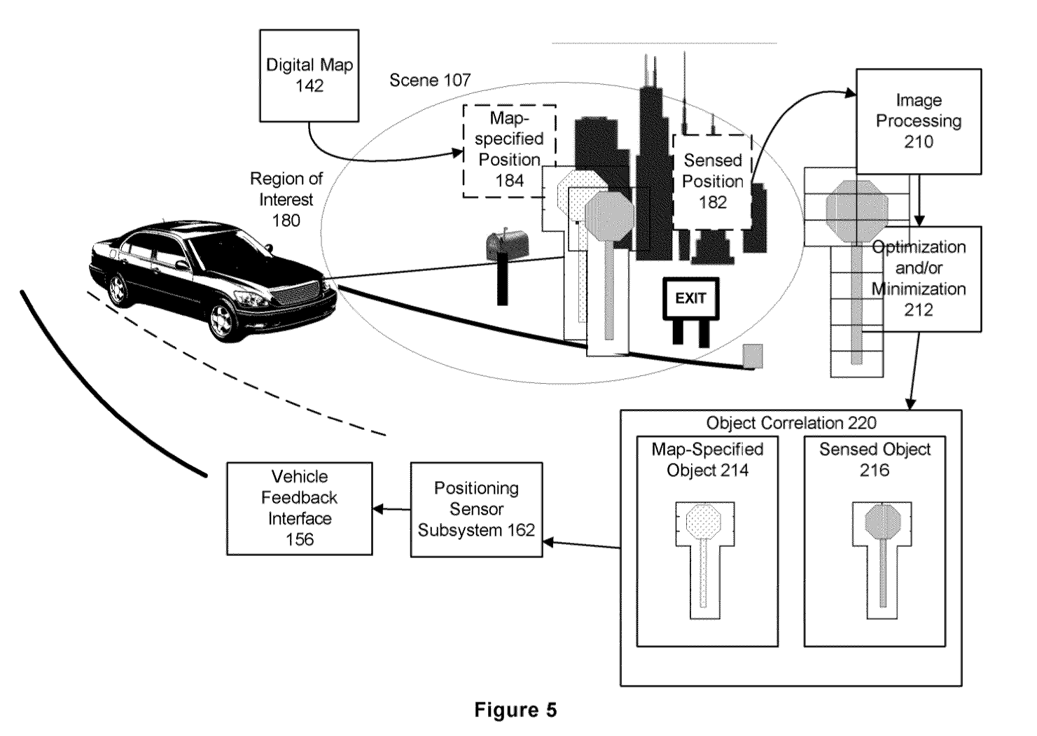

FIG. 5 shows an illustration of a sensor detected object characterization and map matching that uses vehicle-object position matching in accordance with another embodiment. In accordance with an embodiment, the scene matching and correlation function described above can be replaced with object extraction and then image processing algorithm, such as a Hausdorff distance computation, that is then searched for a minimum to determine a matching object. Such embodiment will have to first extract objects from raw sensor data. Such computations are known in the art of image processing, and are useful for generating object or scene matches in complex scenes and with less computation. As such, these computational techniques are of use in a real-time navigation system.

As illustrated by the example shown in FIG. 5, in accordance with some embodiments, objects extracted from sensor data such as a laser scanner and or camera can be superimposed onto a 3D object scene as constructed from the objects in the map database. While the vehicle 100 travels a roadway, and uses sensors 172 to evaluate a region of interest (ROI) 180, it can perceive a scene 107, including a sensed object 182 as a cluster of data. As also described above with regard to FIG. 3, the cluster can be viewed and represented as a plurality of boxes corresponding to the resolution of the laser scanner or other sensing device. The object that generated the laser scan cluster, in this instance a road sign, is again shown in FIG. 5 behind the cluster resolution cells. In accordance with an embodiment, the object can be detected or extracted as a polygon or simple 3D solid object. Each of a plurality of objects are also stored in the map database 142 as raw sensor data (or a compressed version thereof), or as polygons including information for an object 184. The image received from the sensor can be processed 210, and local optimization or minimization techniques 212 can be applied. An example of a local minimum search technique is the Hausdorff technique described above. As described above, in this approach, the raw sensor points are processed by an edge detection means to produce lines or polygons, or, for a 3D set of data, a surface detection means can be used to detect an objects face. Such detection can be provided within the device itself (e.g. by using the laser scanner and/or radar output surface geometry data which define points on a surface). The same process can be applied to both the sensed data 216 and the map data 214. In accordance with some embodiments, to reduce computation time the map data may be already stored in this manner. The Hausdorff distance is computed, and a local minimum search performed. The result is then compared with thresholds or correlated 220, to determine if a sufficiently high level of match has been obtained. This process is computationally efficient and exhibits a good degree of robustness with respect to errors in scale and orientation. The process can also tolerate a certain amount of scene noise. Resulting information can then be passed back to the positioning sensor subsystem 162, or to a vehicle feedback interface 146, for further use by the vehicle and/or driver.

In accordance with some embodiments, the Hausdorff technique can be used to determine which fraction of object points lie within a threshold distance of database points and tested against a threshold. Such embodiments can also be used to compute coordinate shifts in x and z and scale factors that relate to a shift (error) in the y direction.

It will be noted that the Hausdorff distance technique is only one of the many algorithms known to those familiar with the art of image and object matching. In accordance with other embodiments, different algorithms can be suitably applied to the matching problem at hand.

The above example described a simple case, wherein only a single object was present or considered in both the map and as sensed by the vehicle's sensor. In the real world, the density of objects may be such that multiple objects are present in relatively close proximity (say, 1 to 3 meters apart). In these situations, optimization and minimization techniques such as the Hausdorff technique are of particular use. In such situations, the detailed correlation function and/or the Hausdorff distance computation will have sufficient sensitivity to match all features of the objects (as received by the sensor). It is therefore unlikely that the set of objects would be matched incorrectly. For example, even though the spacing of multiple objects are about the same, the detailed correlation would clearly discern the peak of the correlation and not erroneously correlate, for example a mailbox with a lamppost, or a lamppost with a stop sign.

The approach described above is subject to certain errors. Generally, any error in position or orientation will be more complex than simply a shift in the x, y, z coordinates between the vehicle and map version of the scenes. Orientation errors can introduce perspective differences and location errors might produce scaling (size) errors, both of which would result in a lowering of the overall peak in the correlation function. For the case where the vehicle has a good (small) CEP and reasonable estimate of orientation, which will generally be the case as the vehicle makes one or more previous object matches, these errors should not significantly effect the matching performance. Furthermore, in accordance with some embodiments a set of scenes can be constructed to bracket these errors, and the correlation performed on each or the matching algorithm selected may be reasonably tolerant of such mismatches. Depending on the needs of any particular implementation, the design engineer can determine, based on various performance measures, the trade-off between added computation cost versus better correlation/matching performance. In any of the above descriptions, if the result of the correlation/matching does not exceed a minimum threshold then the map matching fails for this sensor scene. This can happen because, the position/orientation has too large an error and/or because the CEP is computed incorrectly too small. It can also happen if too many temporary objects are visible in the Vehicle Scene that were not present during the map acquisition. Such items as people walking, parked cars, construction equipment can dynamically alter the scene. Also, the number and distribution of objects collected versus the number and distribution of objects that make up the true scene and are detected by the sensor will effect correlation performance. Collecting too many objects is unnecessary, and will increase expense and processor load. In contrast, collecting too few of the objects present will leave the system with too much correlation noise to allow it to make reliable matches. The density and type of objects to be stored in the map is an engineering parameter which is dependant on sensor and performance levels desired. The matching function should take into account the fact that not all vehicle sensed objects may be in the map.

In accordance with an embodiment, one of the approaches that is used to ensure that the map stores an adequate number of objects, yet does not become too large or unwieldy a data set, is to run a self correlation simulation of the reality of objects captured, while populating the map with a sufficient subset of those objects that have been collected to achieve adequate correlations for the applications of interest. Such simulations can be made for each possible vehicle position & objects and/or noise simulation.

If the correlation/image process threshold is exceeded, then a maximum can be computed from the various correlations/image processes performed over the various map scenes constructed. With the correlation/image process, the known objects of the map are matched to specific scene objects in the Vehicle Scene. If the vehicle sensor is one that can measure relative position with its sensor, such as a radar or laser scanner, then a full six degrees of freedom for the vehicle can be determined to the accuracy (relative and absolute) of the objects in the database and the errors associated with the sensor. By testing individual object raw data clusters or extracted object polygons, matched to individual sensor cluster returns or extracted object polygons in the Vehicle Scene, the system can make many validity checks to verify that the scene correlation process has resulted in an accurate match. The results thus enable the higher accuracies that are needed by future applications. In accordance with another embodiment, the scene matching and estimation of the six degrees of freedom enable the road map to be superimposed with high accuracy over real time images (such as the real time images described in PCT Patent Application 6132522), or to adjust the depiction in a HUD display of a path intended to align with upcoming roads. In the case of these embodiments, the outcome will be particularly sensitive to the orientation components, which are generally not available using inference-based forms of map matching.

In accordance with some embodiments the object matching may be performed in a series of stages. Linear objects such as lane markings or curbs can be detected and compared to similar objects in the database. Such linear features have the characteristic of being able to help locate the vehicle in one direction (namely orthogonal to the lane marking i.e. orthogonal to the direction of travel). Such an object match may serve to accurately determine the vehicles location with respect to the y direction shown in FIG. 1 above (i.e. with respect to the direction orthogonal to the lane markings, or orthogonal to the direction of the road, which is roughly the same as the heading of the vehicle). This matching serves to reduce the CEP in the y direction which in turn reduces other scene errors, including scale errors, related to poor y measurement. This also reduces the y axis correlation computations. Depending on the particular embodiments, these steps can be enabled by a single sensor, or by separate sensors or separate ROIs.

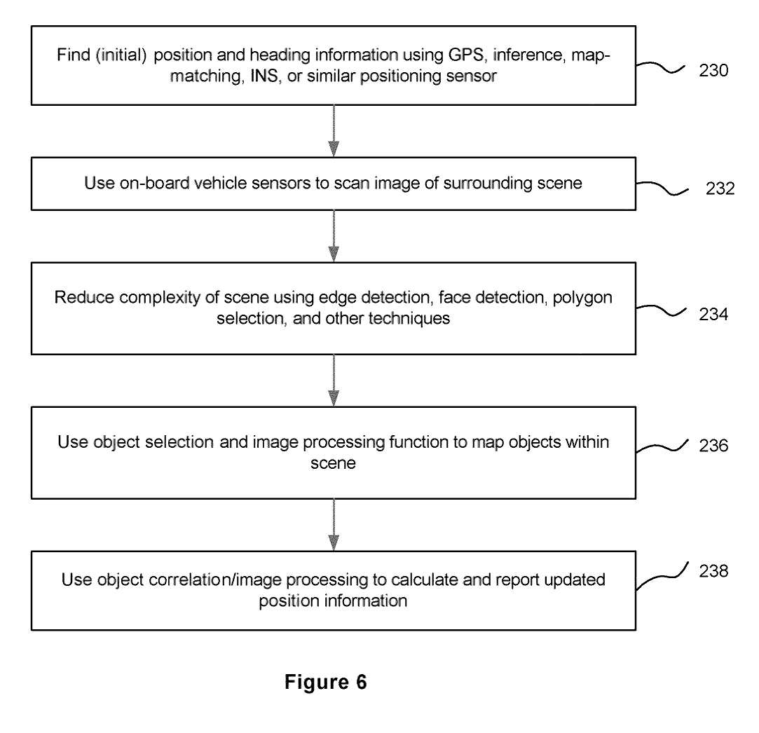

FIG. 6 shows a flowchart of a method for sensor detected object characterization and map matching that uses vehicle-object position matching, in accordance with an embodiment. As shown in FIG. 6, in step 230, the system finds an (initial) position and heading information using GPS, inference, map-matching, INS, or similar positioning sensor. In step 232, the system uses its on-board vehicle sensors to scan or create an image of the surrounding scene. In step 234, the system uses image processing techniques to reduce the complexity of the scene, for example using edge detection, face detection, polygon selection, and other techniques to extract objects. In step 236, the system uses image processing for object selection and matching objects within scenes. In step 238, the system uses the matches to calculate and report updated vehicle position information to the vehicle and/or the driver.

### Object Characterization

In accordance with an embodiment uses object characterization, a system is provided which (a) extracts raw object data from the sensor-gathered or raw data; (b) extracts characteristics from those raw objects; and (c) compares those characteristics with the characteristics that are stored in the map to help provide a more accurate estimate of the vehicle position.

Advantages of this embodiment include that the embodiment requires less processing power and storage demands. The introduction of new characteristics over time will require the map provider to redeliver their map data more frequently. Successful extraction depends on the categories stored in map. If new categories are introduced then the map customer would also have to change the nature of their application platform. Generally, the map customer and map provider should agree beforehand on the stored categories that will be used.

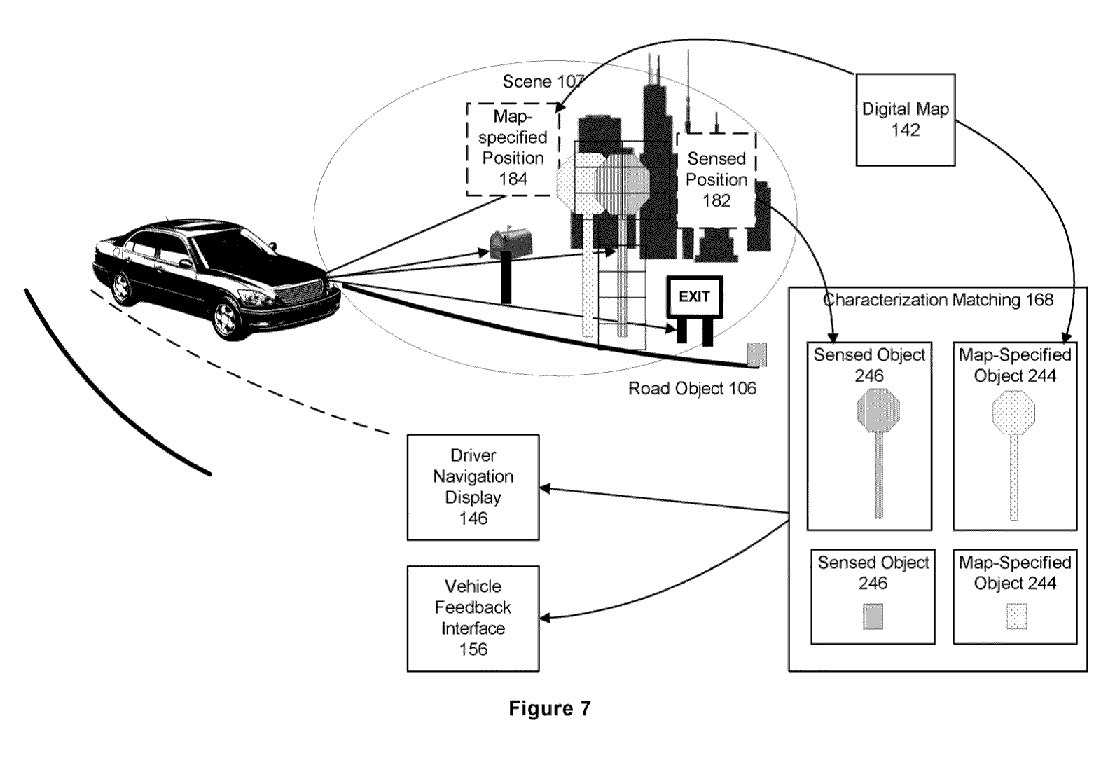

FIG. 7 shows an illustration of a sensor detected object characterization and map matching that uses object characterization in accordance with another embodiment. As shown in FIG. 7, in accordance with this embodiment, the vehicle processes the raw sensor data, extracts objects 246, and uses an object characterization matching logic 168 to match the extracted objects with known objects 244, with, at a minimum, a location and possibly other attributes such as size, specific dimensions, color, reflectivity, radar cross-section, and the like. Many different object identification/extraction algorithms can be used, as will be known to one skilled in the art. High performance object extraction is computationally expensive, but this problem is becoming less of an issue as new algorithms and special purpose processors are being developed.

As with the embodiments described above, the vehicle may have at some initial time only an inaccurate absolute measurement of position. Or after a time of applying the co-pending invention or other forms of sensor improved position determination, it may have matched to several if not many objects or scenes of objects which have served to also define the vehicle's position/orientation in the appropriate relative coordinate space. This may have possibly also improved the vehicle's absolute coordinate estimate. In this case the result of the match may be a more accurate position and orientation estimate at least in relative coordinates and possibly absolute coordinates.

In either case the navigation system can place its current estimated location in the coordinate space of the map (using either absolute or relative coordinates) and an estimate of positional location accuracy can be derived and embodied in its CEP. In the case of an unrefined absolute location the CEP may be moderately large (say 10 meters) and in the case of the relative location the CEP will be proportionately smaller (say 1 meter). In either case the CEP can be computed with respect to the map coordinates, and a point-in-polygon or simple distance algorithm employed to determine which map objects are within that CEP and hence are potential matches to the sensor-detected object or objects. This may be performed in 2D or 3D space.

For example, if the vehicle is approaching a moderately busy intersection, and the sensor detects an object at a range and bearing that, when combined with the position estimate, puts the CEP of the detected object at the sidewalk corner, then if there is only one object within the CEP the matching may be already accomplished. For verification purposes, an object characterization match may be performed.

In accordance with various embodiments, each sensor may have unique object characterization capabilities. For example, a laser scanner might be able to measure the shape of the object to a certain resolution, its size, how flat it is, and its reflectivity. A camera might capture information related to shape, size and color. A camera might only provide a relatively inaccurate estimate of distance to the object, but by seeing the same object from multiple angles or by having multiple cameras, it might also capture sufficient information to compute accurate distance estimates to the object. A radar might possibly measure density, or at least provide a radar size or cross section, and depending on its resolution, might be able to identify shape.

In accordance with an embodiment, objects can also be fitted with radar reflection enhancers, including “corner reflectors” or the like. These small, inexpensive, devices can be mounted on an object so as to increase its detectability, or the range at which it can be detected. These devices can also serve to precisely locate a spatially extended object by creating a strong point-like object within the sensed object's larger signature. So, depending on the sensor there may be several characterizing features of the object which can be used to verify the object match.

One of skill in the art can construct additional ways to use the above mentioned characteristics to match the sensor data to the map data. In accordance with a particular embodiment, laser scanner information (distance and theta—the vertical angle with respect to the platform horizon) is measured by transmitting coherent light from a rotating laser, and receiving that light back from the first object it encounters, can be used to match to an object in the database according to the following algorithm:
Receive sensor returns from an object {distance, theta, value}.
For an object larger than the basic resolution cell of the sensor, aggregate the set of returns by any suitable technique. Examples of aggregation for laser scanner data include output mesh generation and further faces (polygons) generation e.g. by using an algorithm such as a RANdom SAmple Consensus (RANSAC) algorithm, an example of which is described in PCT Patent Application No. 6011865, herein incorporated by reference. Examples of aggregation for images include vectorization, wherein the output is a polygon containing pixels with the same color.
From the aggregated sensor measurements, compute a center of the object (using a centroid calculation or other estimation technique).
Use the computed distance and angles to the sensor-measured object's center, plus the position and orientation information of the sensor with respect to the vehicle platform plus the estimated position of the vehicle (in absolute or relative coordinates) and the combined estimated accuracy of the vehicle's position and sensor position accuracy (CEP) to locate where the object is computed to be within the spatial coordinate system used by the map database. The CEP is an area (2-D) or volume (3-D) representing the uncertainty of the location of the object. Alternatively, instead of using the object center, one can use the estimated location of the object as it meets the ground.
Retrieve all objects within the map centered on the estimated map coordinates and within the area or volume defined by the CEP. The area or volume is a function of whether the design is for a 3D match or a 2D match.
For each retrieved map object (i) compute the distance measured, Di, from the estimated position of the sensed object to the center of that retrieved object and store each distance along with the object ID.
If available, for each retrieved object compare the measured shape (some combination of height, width, depth etc) of the sensed object to the stored shape of each retrieved object. Compute a shape characteristic factor, C1. Instead of a complex shape; height, width and depth may be compared separately. Such shape characteristics can be measured according to any of a variety of available methods, such as physical momentum calculations, Blair Bliss coefficient, Danielson coefficient, Haralick coefficient, or any other suitable characteristic.
If available, for each retrieved object compare the measured flatness against a stored measurement of flatness or a classification of the type of object such as a class=sign object. If available, compute a flatness characteristic factor, C2. If a flat object's plane of orientation can be measured, that too can be a characteristic.
If available, for each retrieved object compare the measured reflectivity against a stored measurement of the reflectivity of the object. Compute a reflectivity characteristic factor, C3.
If available, for each retrieved object, compare the color(s) associated with the sensor detected object to the color(s) associated with the map contained object. Compute a color characteristic factor, C4. One such method of comparison can again be a Hausdorff distance where distance is not a Euclidian distance but a color pallid distance.
If available, for each retrieved object compare any other measured characteristic against similar measurements of that characteristic stored for the object in the map database. Compute the characteristic's factor, Ci. In accordance with an embodiment all factors are normalized to a positive number between 0 and 1.
Weigh each available characteristic's computed factor, Ci according to a preferred weighting, Wi, of how sensitive each characteristic has been determined to be with respect to robust matches.
Sum the weighted scores and normalize and select all weighted scores that pass an acceptance threshold. That is:

Normalized Weighted Score=Sum of (Wi*Ci)/Sum of (Wi)< >Threshold
If there are no objects that pass, then reject object map matching for the current set of measurements.
If there is one, then accept this as the sensor-matched object. Pass its coordinates, characteristics and attribution along to the application requesting such information for example to update/refine the vehicle's position and orientation.
If there are more than one, then rank them according to their weighted score. If the largest weighted score is closer in match distance than the second largest weighted score, by more than a threshold, select the closest as the sensor-matched object, else reject object map matching for the current set of measurements.

It will be recognized to one of skilled in the art that there are many such ways to utilize such characterization information to affect a match algorithm.

The above-described algorithm will provide exacting tests that should make matching-errors rare. In accordance with an embodiment, objects can be stored in the map database at a density such that many match tests could be rejected and the match frequency will still be sufficient to keep an accurate location and orientation in relative coordinate space.

In those cases in which more than one object is sensed and more than one object is in the CEP, then a more complex version of the above algorithm may be used. Each sensed object can be compared as discussed. In addition, pairs of sensed objects represent a measured relationship between them (e.g. a pair may be 2 m apart at a relative bearing difference of 4 deg). This added relationship can be used as a compared characteristic in the weighting algorithm described above to disambiguate the situation. Once an object or set of objects are matched their characteristics and attribution can be passed back to the requesting function.

In those cases in which more than one object is sensed but the objects are not resolved, then the sensed but unresolved objects may be considered as a single complex object. The collected objects in the map database can also be characterized as objects likely resolved or not resolved per different sensor or different sensors with different parameters.

Generally, sensors considered to support in-vehicle applications should have a resolution such that many sensor resolution cells will comprise the response from an object. In the embodiments described above specific characteristics of the object are extracted from this multitude of resolution cells. For example the position of the object is defined by an average or centoid measurement of the extended object or its location where it meets the ground in those cases that it does.

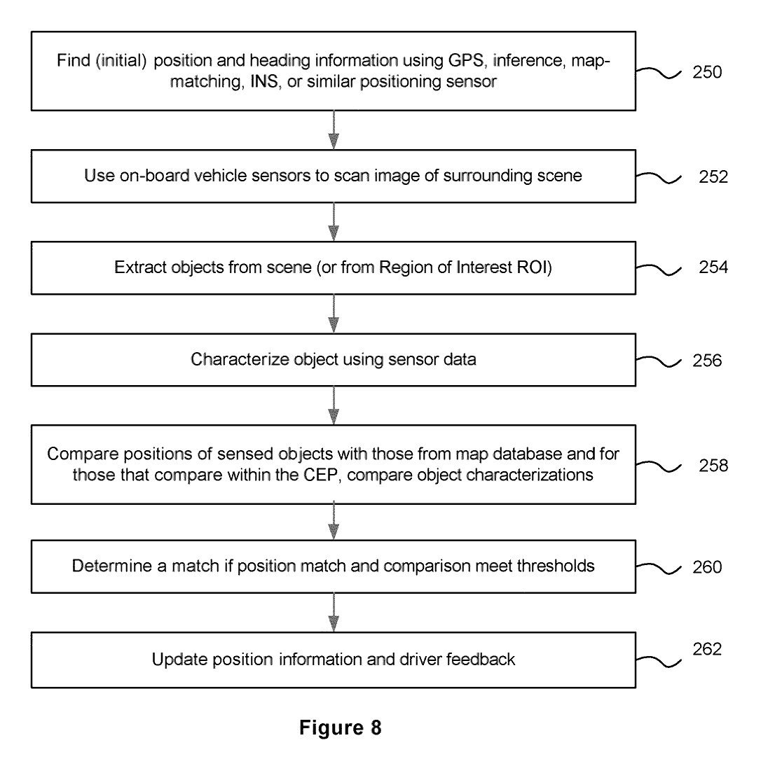

FIG. 8 shows a flowchart of a method for sensor detected object characterization and map matching that uses object characterization, in accordance with an embodiment. As shown in FIG. 8, in step 250, the system finds an (initial) position and heading information using GPS, inference, map-matching, INS, or similar positioning sensor. In step 252, on-board vehicle sensors are used to scan an image of the surrounding scene. In step 254, the system extracts objects from the scene (or from a Region of Interest ROI). In step 256, objects are characterized using sensor data. In step 258, the system compares the positions of sensed objects with those from the map database. The system can then compare object characterizations. In step 260, if the system determines that the positions match and comparisons meet certain thresholds, then it determines a match for that object. In step 262, the position information is updated, and/or driver feedback is provided.

### Object ID Sensor Augmentation

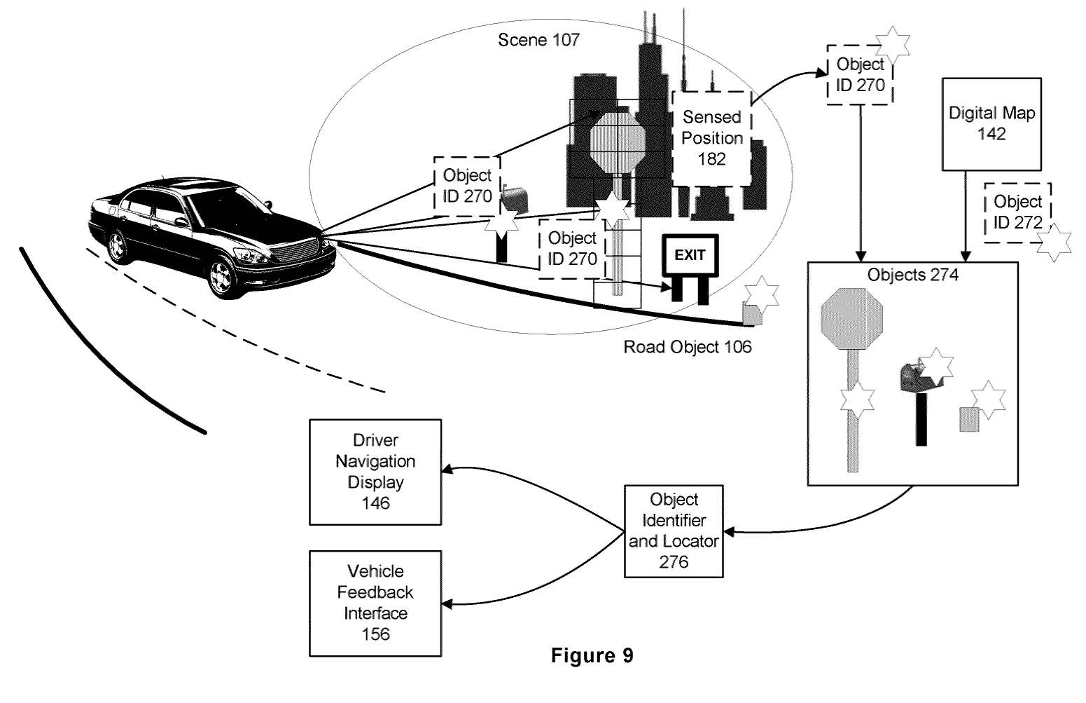

FIG. 9 shows an illustration of a sensor detected object characterization and map matching that uses sensor augmentation in accordance with another embodiment. In the previously-described embodiments, objects were generally detected and assessed by the navigation system based on unaided sensor measurements. In accordance with an embodiment, the sensor measurements are aided or augmented by augmentation devices. Augmentation can include, for example, the use of a radar or laser reflector. In this instance the augmentation device can be a laser reflector that artificially brightens the return from a particular location on the object. The existence of such bright spots can be captured and stored in the map database, and later used to aid in both the matching process, as well as becoming a localized and well defined point to measure position and orientation with. Such corner reflectors and the like are well known in the radar and laser arts.

In accordance with another embodiment, the system can use an ID tag 270, such as an RFID tag. Such devices transmit an identification code that can be easily detected by a suitable receiver and decoded to yield its identifier or ID. The ID can be looked-up in, or compared with, a table of ID's 272 either within the map database or associated with the map database or other spatial representation. The ID can be associated with a specific object or with a type or class of object 274 (for example, a stop sign, mailbox, or street corner). Generally, the spacing of signs such as stop signs, and the accuracy of the vehicle's position estimation, are sufficient to avoid uncertainty or ambiguity as to which sensed object is associated with which RFID tag. In this way, the object identifier 276 or matching algorithm can include a rapid and certain means to unambiguously match the sensed object with the map appropriate map object.

In accordance with another embodiment the system can use a combination of RFID technology with, say, a reflector. If the RFID is collocated with the reflector then this can serve as a positive identification characteristic. Furthermore, the RFID can be controlled to broadcast a unique identification code or additional flag, only when the reflector (or other sensor) is illuminated by an in-vehicle sensor, say a scanning laser. This allows the device to act as a transponder and creates a highly precise time correlation between the reception of the signal and the reception of the RFID tag. This positive ID match improves (and may even render unnecessary) several of the above-described spatial matching techniques, since a positive ID match improves both the reliability and positional accuracy of any such match. This technique is particularly useful in situations of dense objects, or a dense field of RFID tags.

In accordance with another embodiment, bar codes, sema codes (a form of two-dimensional bar code), or similar codes and identification devices can be placed on objects at sufficient size to be read by optical and other sensing devices. Sensor returns, such as camera or video images, can be processed to detect and read such codes and compare them to stored map data. Precise and robust matches can also be performed in this way.

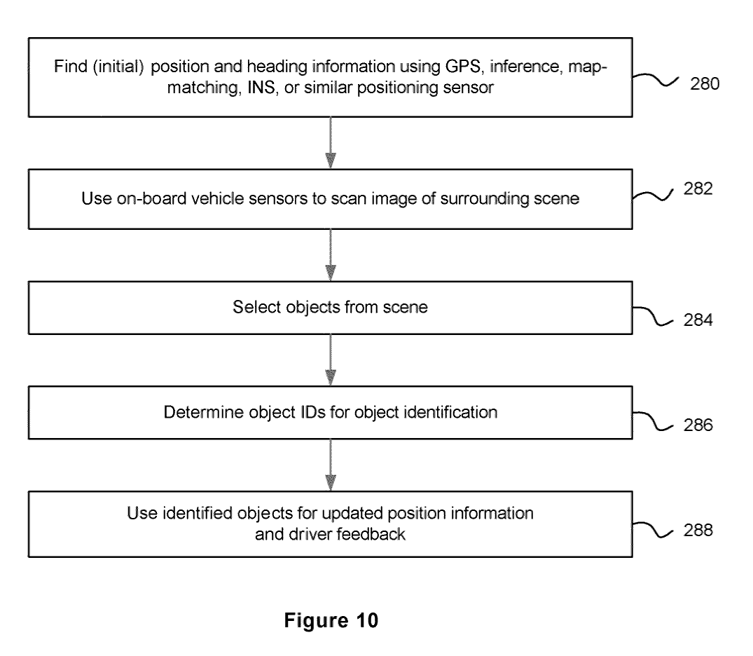

FIG. 10 shows a flowchart of a method for sensor detected object characterization and map matching that uses sensor augmentation, in accordance with an embodiment. As shown in FIG. 10, in step 280, the system finds an (initial) position and heading information using GPS, inference, map-matching, INS, or similar positioning sensor. In step 282, the system uses on-board vehicle sensors to scan an image of the surrounding scene. In step 284, the system selects one or more objects from the scene for further identification. In step 286, the system determines object IDs for those objects and uses this information to compare with stored object IDs (such as from a map database) and to provide an accurate object identification. In step 288, the system can use the identified objects for updated position information, and to provide driver feedback.

### Additional Features

It will be evident that the scenes shown in the figures above represent just a few of many possible scenes that could be created. The x-z correlation is designed to find the best match in those two dimensions. However, if any of the other coordinates of the navigation system's Position and Orientation estimates are in error, then the scenes will not correlate as well as possible. In accordance with various embodiments, additional features and data can be used to reduce this error, and improve correlation.

For example, consider the vehicle's heading. The car will nominally be heading parallel to the road but may be changing lanes, and so the heading is not exactly that of the road. The vehicle's navigation system estimates heading based on the road and its internal sensors like GPS and INS sensors. But still there can be an error of several degrees in the true instantaneous heading of the vehicle versus the estimated heading of the vehicle. Because the sensor is fixed-mounted to the vehicle there should be very little error introduced when rotating from that of the vehicle's heading to that of the sensor's heading (pointing direction). Still, there is a combined estimate of heading error. The computation of the scene from the map data is sensitive to heading error under certain configurations of objects. For the current embodiment other scenes can be computed from the map objects at different headings bracketing the Estimated Heading. These different heading scenes can each be correlated with the Vehicle Scene, as done above, to find a maximum correlation. Again the choice or range of heading scenes and increment of heading scene (e.g. one scene for every degree of heading) is best left to the design engineer of the system to be implemented.

Consider the vehicle's pitch. For the most part the vehicle's pitch will be parallel to the surface of the road—that is to say it will be on the same slope that the road is on. The map database of objects can store the objects relative to the pitch of the road or can store pitch (slope) directly. There may be deviations in pitch, from the slope of the vehicle. For example, accelerations and decelerations can change the pitch of the car, as can bumps and potholes. Again, all these pitch changes can be measured but it should be assumed that the pitch error can be a few degrees. The computation of the scene from the map data is sensitive to pitch error under certain configurations of objects. For the current embodiment other scenes can be computed from the map objects at different pitches bracketing the Estimated Pitch. These different pitch scenes can each be correlated with the Vehicle Scene to find a maximum correlation. Again the choice or range of pitch scenes and increment of pitch scene (e.g. one scene for every degree of pitch) is best left to the design engineer of the system to be implemented. The maximum correlation will offer feedback to correct the vehicle's estimate of pitch.

Consider the vehicle's roll. For the most part the vehicle's roll will be parallel to the surface of the road—that is to say the vehicle is not tilting towards the driver side or towards the passenger side but is riding straight and level. However, on some roads there is a pronounced crown. Thus the road is not flat and level and a car will experience a roll of several degrees from horizontal if it is driving off the top of the crown, say on one of the outer lanes. The map may contain roll information about the road as an attribute. In addition, there may be deviations in the actual roll of the vehicle, as can be caused by bumps and potholes and the like. Again, all these roll changes can be measured but it should be assumed that the roll can be in error by a few degrees. The computation of the scene from the map data is sensitive to roll error under certain configurations of objects. For the current embodiment other scenes can be computed from the map objects at different rolls bracketing the Estimated Roll. These different roll scenes can each be correlated with the Vehicle Scene to find a maximum correlation. Again the choice or range of roll scenes and increment of roll scene (e.g. one scene for every degree of roll) is best left to the design engineer of the system to be implemented. The maximum correlation can offer feedback to correct the vehicle's estimate of roll.

Consider the vehicle's y position, that is to say the vehicle's position orthogonal to the direction of travel. This is mostly a measure of what lane the vehicle is in or the measure of displacement of the vehicle from the centerline of the road. It is also the basic measurement to determine what lane the vehicle is in. Traditional inferential map matching had no method to make this estimate. If the vehicle was judged to be matched to the road, it was placed on the road's centerline, or some computed distance from it, and no finer estimation could be made. This is totally inadequate for applications that require knowledge of what lane the car is in.

The vehicle's y position will vary depending upon which lane the vehicle is in. The vehicle's position determination will estimate the absolute position but may have significant error in this sensitive dimension. It should be assumed that the error in the y-dimension is estimated by the CEP and can amount to several meters. An error in y position results generally in a scale change of the scene. So for example, if the y position is closer to the sidewalk, objects on the sidewalk should appear bigger and further apart and conversely, if the y position is closer to the center line of the road, objects on the sidewalk should appear smaller and closer together. As described, the computation of the scene from the map data is sensitive to the y position of the vehicle if the scene is generated in relative coordinates as for example in the current embodiment. (If the scene is generated in absolute coordinates than sizes should be scale independent.) For the current embodiment other scenes can be computed from the map objects at different y's bracketing the estimated y position. Again, the choice of range of y-position scenes and increment of y-position scene (e.g. one scene for every meter of y-position) is best left to the design engineer of the system to be implemented. The maximum correlation can offer feedback to correct the vehicle's estimate of its y position, which in turn can improve the estimate of which lane it is in.

As mentioned above, these different scenes can each be correlated with the Vehicle Scene to find a maximum correlation. One way to simplify this process is to, from the sensor measurements, compute a measurement of the average building distance. If this is roughly constant for the scene, and buildings are captured in the map database, then a good estimate of the y position can be derived from that measurement.

A given object may be characterized by a point cluster or set of sensed point cells CI(x,y,z). These raw point cells may be stored in the map database for each sensor measured. For example, each laser scanner point that reflects from the object is characterized by a dl and a thetal. With the vehicle location and platform parameters, these can be translated into a set of points in relative coordinates (x,y,z) or in absolute coordinates (latitude, longitude, height) or other such convenient coordinate system. Other data may be stored for each xyz cell, such as color or intensity, depending upon the sensor involved. The database may store, for the same object, different cluster information for different sensors.

When the vehicle passes the object and the vehicles sensor(s) scans the object it too will get a set of points with the same parameters (perhaps at different resolutions).

Again a centroid calculation is made and the location of the CEP is found within the map. Again all objects are retrieved that fall within the CEP but in this case additional information is retrieved such as the raw sensor data (raw point cluster), at least for the sensors known to be active on the vehicle at that time.

The two sets of raw cluster data are normalized to a common resolution size (common in the art). Using the three dimensional cluster points from the sensed object and each retrieved object, a correlation function is applied. The start correlation point is where the centroid of the raw sensor is matched to the centroid of a candidate object. The correlation result can be weighted and factored into the algorithm as another characteristic.

The present invention may be conveniently implemented using a conventional general purpose or a specialized digital computer or microprocessor programmed according to the teachings of the present disclosure, as will be apparent to those skilled in the computer art. Appropriate software coding can readily be prepared by skilled programmers based on the teachings of the present disclosure, as will be apparent to those skilled in the software art. The selection and programming of suitable sensors for use with the navigation system can also readily be prepared by those skilled in the art. The invention may also be implemented by the preparation of application specific integrated circuits, sensors, and electronics, or by interconnecting an appropriate network of conventional component circuits, as will be readily apparent to those skilled in the art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD ROMs, microdrive, and magneto optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above. Included in the programming (software) of the general/specialized computer or microprocessor are software modules for.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, while the invention has been primarily described in the context of position determination enhancement, this is just one of many applications of this combined map matching. For example, the location of a road intersection and its cross walks can be accurately determined as a distance from identified signs, so more accurate turn indications can be given or cross walk warnings given. For another example, the location of the vehicle lateral to the road (with respect to lanes) can be accurately determined to give guidance on which lane to be in, perhaps for an upcoming maneuver or because of traffic etc. By way of additional examples, the matching can be used to accurately register map features on a real-time image collected in the vehicle. In still another example, embodiments of the present invention can be used to provide icon or other visual/audible enhancements to enable the driver to know the exact location of signs and their contexts. It will also be evident that, while many of the embodiments describe the use of relative coordinates, embodiments of the system can also be used in environments that utilize absolute coordinates. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method comprising the steps of:
detecting at least one of a plurality of objects in the vicinity of a vehicle, using a sensor of said vehicle and estimating characteristics about said object, said sensor being calibrated to the position and orientation of said vehicle using GPS or another position and/or orientation-determination technology,
estimating a location of said sensed object from position and orientation estimates of said vehicle, and at least some of the measurements of the sensor;
querying a map or image database by vehicle position or estimated sensed object location, said database allowing information to be retrieved for one or more of a plurality of objects, to extract at least one object depicted in said database for that position; and
comparing the sensed object with the extracted object using a comparison logic, and, if such comparison is successful to a predetermined degree, effecting one or more of
an adjustment of the GPS or otherwise-determined position or orientation of the vehicle,
an adjustment of the position information for the extracted object as appearing in the database, or
a graphical display of the extracted, database-depicted object as an icon or other graphical image on a graphical display of a navigation unit in an appropriate position as regards map data being concurrently displayed thereon being representative of the environs of current vehicle position.

2. The method of claim 1, further comprising:
estimating the vehicle's position and orientation together with an estimate of the accuracy of that positional estimate; and
retrieving, from the map database, object data for any objects that fall within the accuracy estimate centered on the estimated object position.

3. The method of claim 1, wherein the comparison logic compares one or more of the size, shape, height, visible color, degree of flat surface, or reflectivity of said object.

4. The method of claim 1, wherein if the set of objects extracted is only one object, then said object is matched if its comparison function passes a threshold test.

5. The method of claim 1, further comprising:
estimating the vehicle's position and orientation together with an estimate of the accuracy of that positional estimate;
retrieving, from the map database, object data for any objects that fall within the accuracy estimate centered on the estimated object position; and
wherein if the set of objects extracted is only one object, then said object is matched if its comparison function passes a threshold test.

6. The method of claim 1, wherein if no object is within the estimate of positional location accuracy or contour of equal probability (CEP) then no match is made.

7. The method of claim 1, wherein if the set of objects retrieved is more than one object, then said object is matched if its score is best, and passes said threshold and its score is better than a second threshold of the next best score.

8. The method of claim 1, further comprising:
estimating the vehicle's position and orientation together with an estimate of the accuracy of that positional estimate;
retrieving, from the map database, object data for any objects that fall within the accuracy estimate centered on the estimated object position; and
wherein if the set of objects retrieved is more than one object, then said object is matched if its score is best, and passes said threshold and its score is better than a second threshold of the next best score.

9. The method of claim 1, wherein the characteristics stored in said map database for each object include characteristics from more than one sensor type.

10. The method of claim 5, wherein the characteristics stored in said map database for each object include characteristics from more than one sensor type.

11. The method of claim 8, wherein the characteristics stored in said map database for each object include characteristics from more than one sensor type.

12. The method of claim 2 wherein said estimated accuracy is a combination of the vehicle's current positional accuracy and said basic sensor accuracy.

13. The method of claim 2, wherein accuracy estimates are defined in one of a 2D space or a 3D space.

14. The method of claim 12, wherein accuracy estimates are defined in one of a 2D space or a 3D space.

15. The method of claim 1, wherein a characteristic of said objects are their point clusters, and wherein one comparison is a correlation function between the sensed object point cluster and the extracted object point cluster.

16. The method of claim 15, wherein the map database contains point clusters for different sensors.

17. The method of claim 15, wherein said correlation is centered around the centroid of sensed and extracted objects.

18. The method of claim 1, wherein one of the sensed characteristics of an object is the reception of an RFID that is linked to an object.

19. The method of claim 1, wherein the object is provided with a corner reflector and is linked to a transponder such that an RFID signal is broadcast when the reflector is illuminated by the sensor.

20. The method of claim 1, wherein the method is used for calibration between an image collected in a vehicle, and the road network, so that the road network and other elements of the map can be superimposed on real-time camera images collected in the car and shown to the driver.

21. The method of claim 1, wherein said comparison logic uses image matching technology, including a computation of the Hausdorff Distance.

22. A system comprising:
an interface to one or more sensors, for detecting at least one of a plurality of objects in the vicinity of a vehicle, using a sensor of said vehicle and estimating characteristics about said object, said sensor being calibrated to the position and orientation of said vehicle using GPS or another position and/or orientation-determination technology;
an interface for querying a map or image database by vehicle position or estimated sensed object location, said database allowing information to be retrieved for one or more of a plurality of objects, to extract at least one object depicted in said database for that position; and
a logic for
estimating a location of said sensed object from position and orientation estimates of said vehicle, and at least some of the measurements of the sensor, and
comparing the sensed object with the extracted object and, if such comparison is successful to a predetermined degree, effecting one or more of
an adjustment of the GPS or otherwise-determined position or orientation of the vehicle,
an adjustment of the position information for the extracted object as appearing in the database, or
a graphical display of the extracted, database-depicted object as an icon or other graphical image on a graphical display of a navigation unit in an appropriate position as regards map data being concurrently displayed thereon being representative of the environs of current vehicle position.

23. The system of claim 22, wherein the system further:
estimates the vehicle's position and orientation together with an estimate of the accuracy of that positional estimate; and
retrieves, from the map database, object data for any objects that fall within the accuracy estimate centered on the estimated object position.

24. The system of claim 22, wherein if the set of objects extracted is only one object, then said object is matched if its comparison function passes a threshold test.

25. The system of claim 22, wherein if the set of objects retrieved is more than one object, then said object is matched if its score is best, and passes said threshold and its score is better than a second threshold of the next best score.

26. A computer readable medium, including instructions stored thereon, which when read and executed by a computer cause the computer to perform the steps comprising:
detecting at least one of a plurality of objects in the vicinity of a vehicle, using a sensor of said vehicle and estimating characteristics about said object, said sensor being calibrated to the position and orientation of said vehicle using GPS or another position and/or orientation-determination technology,
estimating a location of said sensed object from position and orientation estimates of said vehicle, and at least some of the measurements of the sensor;
querying a map or image database by vehicle position or estimated sensed object location, said database allowing information to be retrieved for one or more of a plurality of objects, to extract at least one object depicted in said database for that position; and
comparing the sensed object with the extracted object using a comparison logic, and, if such comparison is successful to a predetermined degree, effecting one or more of
an adjustment of the GPS or otherwise-determined position or orientation of the vehicle,
an adjustment of the position information for the extracted object as appearing in the database, or
a graphical display of the extracted, database-depicted object as an icon or other graphical image on a graphical display of a navigation unit in an appropriate position as regards map data being concurrently displayed thereon being representative of the environs of current vehicle position.
